(19) United States
(12) Patent Application Publication
(10) Pub. No.: US 2014/0161474 A1
(43) Pub. Date: Jun. 12, 2014

(54) IMAGE FORMING APPARATUS

(71) Applicant: FUJI XEROX CO., LTD., Tokyo (JP)

(72) Inventor: Yasuhiro ODA, Kanagawa (JP)

(21) Appl. No.: 13/917,867

(22) Filed: Jun. 14, 2013

(30) Foreign Application Priority Data
Dec. 11, 2012 (JP) 2012-270453

(51) Int. Cl. G03G 21/12

(52) U.S. Cl. CPC G03G 21/105
USPC 399/35

(57) ABSTRACT

An image forming apparatus includes an image output unit that forms an image with developer, a gathering unit that gathers developer not used by the image output unit as waste developer, plural collection containers that store and collect the waste developer, a transport device that transports the waste developer toward one of the collection containers and includes a discharge portion which is connected to the one of the collection containers, a moving device that moves the collection containers together to respective predetermined arrangement positions including a collection position for connection to the discharge portion and an attachment/detachment position, and a full-state detector that detects that the collection container at the collection position is in an almost full state. A selected one of the collection containers is preferentially moved to the collection position when the other collection container detected by the full-state detector is detached.

### CROSS-REFERENCE TO RELATED APPLICATIONS

This application is based on and claims priority under 35 USC 119 from Japanese Patent Application No. 2012-270453 filed Dec. 11, 2012.

### BACKGROUND

(i) Technical Field

The present invention relates to an image forming apparatus.

(ii) Related Art

There are image forming apparatuses such as copiers and printers that form images with developer. Some of these image forming apparatuses use a collection system in which, for example, a discharge device such as a cleaning device gathers and discharges, as waste developer, developer not used by an image forming device when an image developed by developer is transferred onto a recording medium such as recording paper, and the discharged waste developer is transported into a detachable and replaceable container through a transport pipe so as to be collected into the container.

### SUMMARY

According to an aspect of the invention, there is provided an image forming apparatus including: an image output unit that forms an image with developer on a recording medium so as to output the image; a gathering unit that gathers developer not used by the image output unit as waste developer; plural detachable and replaceable collection containers that store and collect the waste developer gathered by the gathering unit; a transport device that transports the waste developer gathered by the gathering unit toward one of the plural collection containers, the transport device including a discharge portion which is connected to the one of the collection containers to allow the transported waste developer to be discharged; a moving device that moves the plural collection containers together such that the plural collection containers reach and stop at respective predetermined arrangement positions, the predetermined arrangement positions including a collection position for connection to the discharge portion of the transport device and an attachment/detachment position which is located at a different position from the collection position and at which attachment and detachment for replacement are performed; and a full-state detector that detects that the one of the collection containers moved and stopped at the collection position by the moving device and storing the waste developer is in an almost full state; wherein a selected one of the plural collection containers is preferentially moved to the collection position so as to store the waste developer when the other one of the collection containers detected by the full-state detector is moved from the collection position to the attachment/detachment position and detached therefrom.

### BRIEF DESCRIPTION OF THE DRAWINGS

Exemplary embodiments of the present invention will be described in detail based on the following figures, wherein:

FIG. 1 schematically illustrates an image forming apparatus according to a first exemplary embodiment;

FIG. 2 is a conceptual diagram showing a part (an image forming device and a developer replenishment system) of the image forming apparatus of FIG. 1;

FIG. 3 is a partial cross-sectional view showing the configuration of a collection system for waste developer and the like which is provided in the image forming apparatus of FIG. 1;

FIG. 4 is a diagram showing the outline of a collection container and the configuration of components therearound;

FIG. 5 is a partial cross-sectional view showing the configuration of two collection containers, a moving device therefor, and other components;

FIGS. 6A and 6B are partial cross-sectional views each showing the two collection containers moved to predetermined arrangement positions;

FIG. 7A is a top view of an openable shutter of the moving device;

FIG. 7B is a schematic cross-sectional view of the openable shutter of FIG. 7A taken along the line VIIB-VIIB;

FIG. 8 is a block diagram schematically showing the configuration of a control system of the image forming apparatus;

FIGS. 9 and 10 are flowcharts showing a control operation of the collection system during execution of an image forming operation; and

FIGS. 11A through 11C illustrate a part (a full-state detection sensor at a collection position and the configuration of components therearound) of a collection system according to a second exemplary embodiment.

### DETAILED DESCRIPTION

The following describes exemplary embodiments of the present invention (hereinafter simply referred to as the “exemplary embodiments”) with reference to the accompanying drawings.

### First Exemplary Embodiment

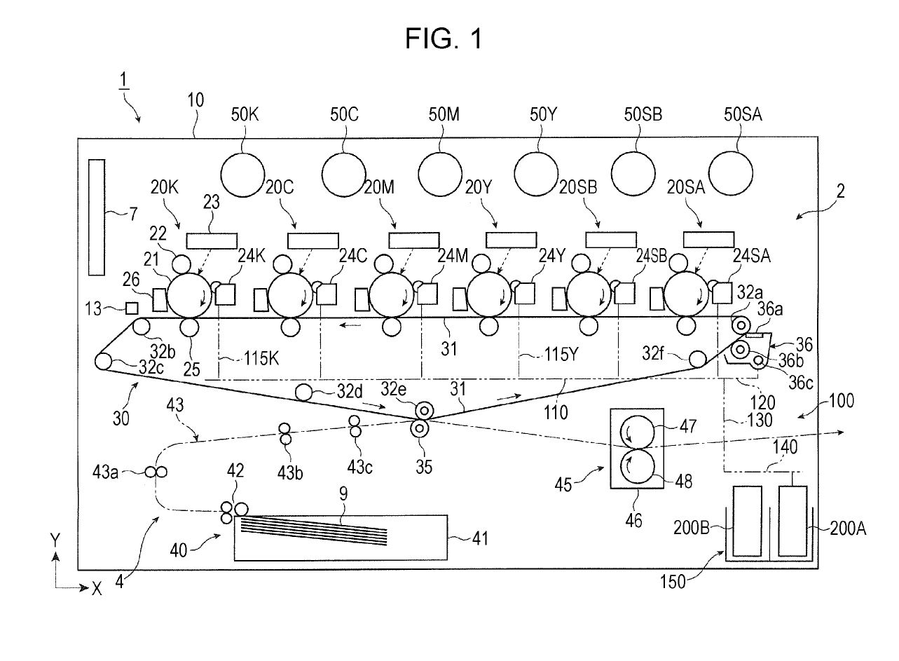

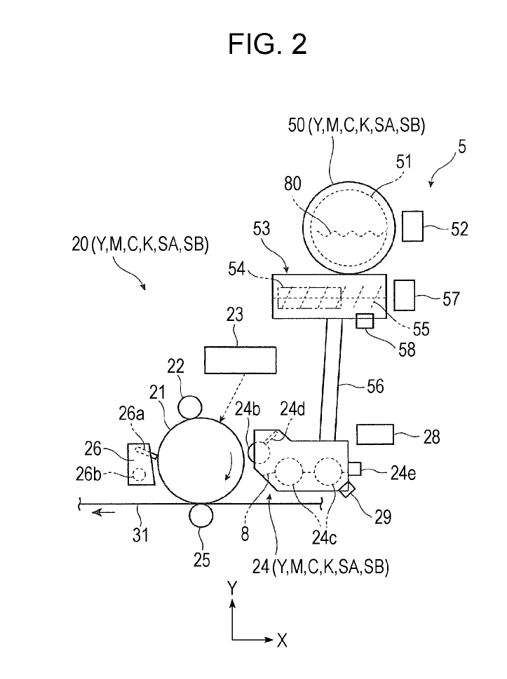

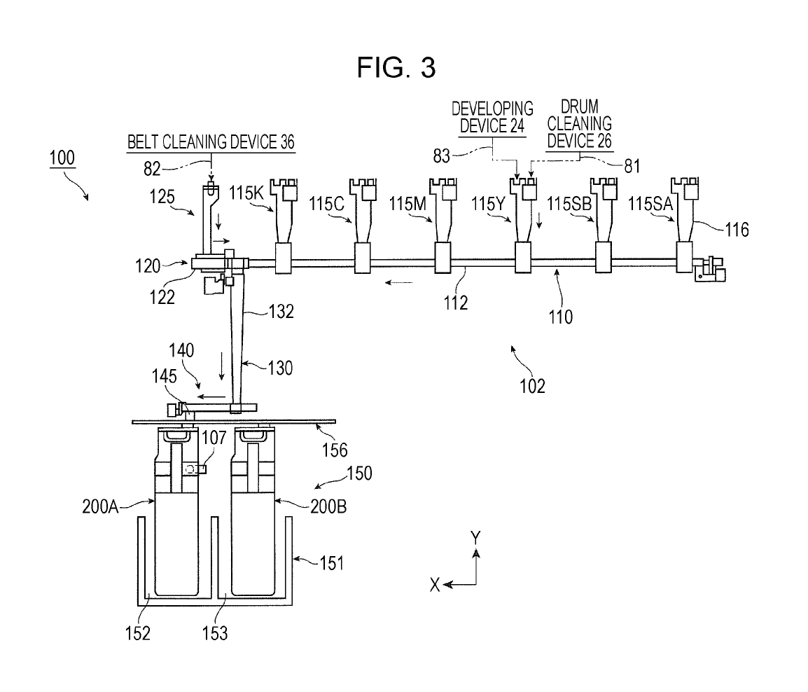

FIG. 1 schematically illustrates an image forming apparatus 1 according to a first exemplary embodiment. FIG. 2 illustrates a part (an image forming device and a developer replenishment system) of the image forming apparatus 1. FIG. 3 illustrates another part (a waste developer collection system) of the image forming apparatus 1.

(Overall Configuration of Image Forming Apparatus)

The image forming apparatus 1 according to the first exemplary embodiment may be a color printer, for example. As shown in FIG. 1, this image forming apparatus 1 includes, in the internal space of a housing 10, an image output unit 2 that forms an image with developer on recording paper 9, which is an example of recording media, so as to output the image, a paper feed unit 4 that stores and feeds predetermined recording paper 9 to the image output unit 2, a waste developer collection system 100 that gathers, as waste developer, developer not used by the image output unit 2 and then collects the waste developer, a control device 7, and the like. In the drawings, the one-dot chain line indicates a transport path through which the recording paper 9 is generally transported within the housing 10.

The image output unit 2 generally includes plural image forming devices 20 that form toner images to be developed with toner (colored particles) contained in developer, using a known image forming system such as an electrophotographic system and an electrostatic recording system, an intermediate transfer device 30 that temporarily holds the toner images formed by the image forming devices 20 and transfers the toner images onto the recording paper 9, and a fixing device 45 that fixes the toner images, which have been transferred onto the recording paper 9 by the intermediate transfer device 30, while the recording paper 9 passes therethrough. The paper feed unit 4 generally includes a paper feed device 40 that stores and feeds the recording paper 9, and a paper feed path 43 through which the recording paper 9 fed from the paper feed device 40 is transported to a second transfer unit of the intermediate transfer device 30.

The image forming device 20 of the image output unit 2 includes six image forming devices 20Y, 20M, 20C, 20K, 20SA, and 20SB dedicated to forming four toner images of yellow (Y), magenta (M), cyan (C), and black (K), and special-color toner images of special colors SA and SB. The six image forming devices 20 (Y, M, C, K, SA, and SB) are arranged in tandem within the internal space of the housing 10. As will be described below, the image forming devices 20 (Y, M, C, K, SA, and SB) have substantially the same configuration.

As shown in FIGS. 1 and 2, each of the image forming devices 20 (Y, M, C, K, SA, and SB) has a photoconductor drum 21 that rotates in the direction indicated by the arrow. In the vicinity of the photoconductor drum 21, the following devices are generally arranged: a charging device 22 that charges a peripheral surface (more specifically, an image holding surface which may be charged such that a latent image is formed thereon) of the photoconductor drum 21 to a predetermined potential; an exposure device 23 that radiates light to the charged peripheral surface of the photoconductor drum 21 on the basis of image information (signal) so as to form an electrostatic latent image using a potential difference (for each color), a developing device 24 (Y, M, C, K, SA, and SB) that develops the electrostatic latent image into a visible toner image with a toner of developer of the corresponding color (Y, M, C, K, SA and SB), a first transfer device 25 that transfers the toner image onto (an intermediate transfer belt of) the intermediate transfer device 30, and a drum cleaning device 26 that removes attached substances, such as toner, remaining on and attached to the peripheral surface of the photoconductor drum 21 after the transfer.

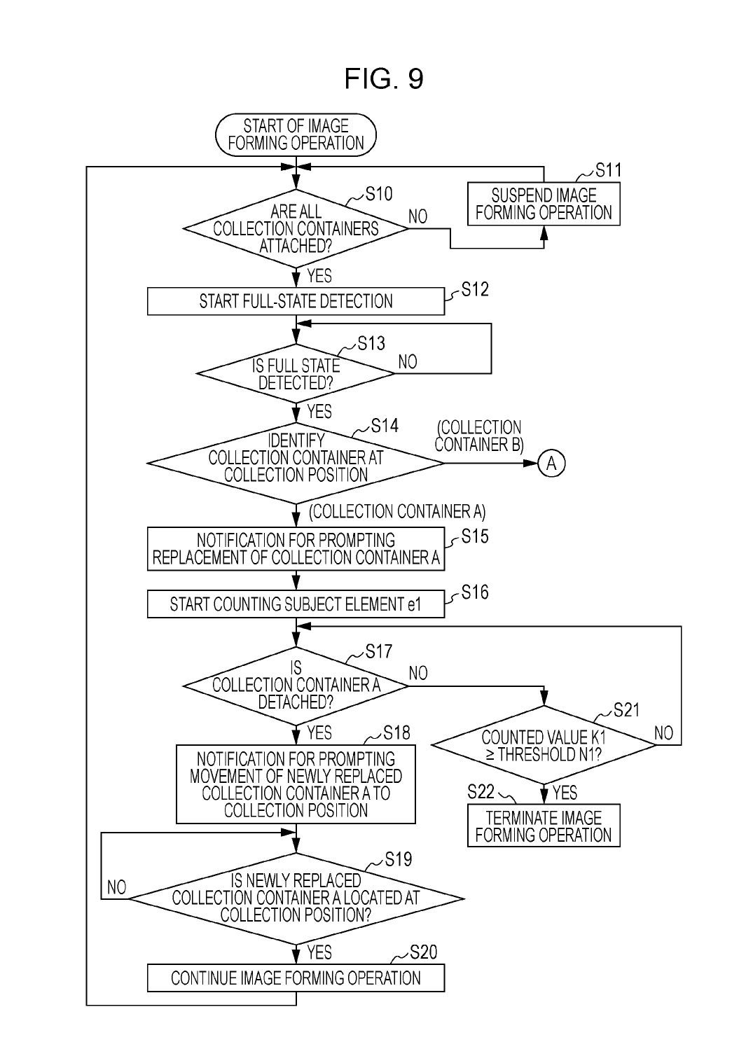

With regard to the exposure device 23, information on an image to be printed is input to the image forming apparatus 1, and an image processing device 12 (not shown) (FIG. 8: image processing unit) performs required image processing on the information such that image signals of respective color components obtained by the image processing are transmitted to an exposure driver (not shown). The image forming apparatus 1 may be connected to image information devices (not shown) including an image reading device, an information terminal such as a computer, and a recording medium reader/writer, through an external connection communication unit 13. Thus, image information is input from the image information devices to the image forming apparatus 1.

As best shown in FIG. 2, each of the developing devices 24 (Y, M, C, K, SA, and SB) includes a developer storage container 24a that stores two-component developer 8 which contains non-magnetic toner, including a predetermined color component, and magnetic carrier. In the developer storage container 24a, a developing roller 24b, an agitating and transport member 24c, and a layer thickness regulating member 24d are provided. The developing roller 24b rotates and holds the two-component developer 8 so as to transport the two-component developer 8 to a developing region close to and facing the photoconductor drum 21. The agitating and transport member 24c transports the stored developer 8 to the developing roller 24b while rotating and agitating the developer 8. The layer thickness regulating member 24d regulates the amount (thickness) of the developer held by the developing roller 24b. The toners of the developers 8 of the special colors SA and SB are formed of color materials of colors that are difficult or impossible to be created with the above four colors, for example. More specifically, the toners of the special colors may include toners of colors other than the above four colors, foam toner for Braille, fluorescent toner, and glossy toner.

Further, as shown in FIG. 2, each of the developing devices 24 (Y, M, C, K, SA, and SB) is supplied with a corresponding developer from a developer replenishment system 5. The replenishment system 5 includes developer cartridges 50 (Y, M, C, K, SA, and SB) for storing replenishment developers (non-magnetic toner containing magnetic carrier) 80 of four colors (Y, M, C, and K) and special colors (SA and SB), and replenishment devices 53 (Y, M, C, K, SA, and SB) that respectively transport the required amount of replenishment toners 80 from the developer cartridges 50 to the developing devices 24 when needed. Each developer cartridge 50 is a detachable and replaceable cartridge which may be detachably attached to a cartridge attachment portion of the housing 10 and may be easily replaced.

Each replenishment device 53 receives and temporarily stores replenishment developer discharged from an outlet port of the corresponding developer cartridge 50, and sends the stored replenishment developer toward the corresponding developing device 24. The replenishment developer sent from the replenishment device 53 is transported to the corresponding developing device 24 through a connection transport device 56. In FIG. 2 and other drawings, the reference numeral 52 denotes a driving device for rotating a transport member 51 that transports the replenishment developer from the developer cartridge 50 toward the outlet port. The reference numeral 57 denotes a driving device for rotating a sending member 54 and the like that send a portion of the replenishment developer stored in the replenishment device 53 toward a sending port, and the reference numeral 55 denotes an agitating and transport member that circulates and transports the replenishment toner stored in the replenishment device 53 such that the replenishment toner passes near the sending member 54 while agitating the replenishment developer. Further, the reference numeral 58 denotes a remaining amount detection sensor that detects whether the amount of replenishment developer stored in the replenishment device 53 is equal to or greater than a predetermined value, and the reference numeral 29 denotes a toner density detection sensor that detects the toner density of the developer (the proportion of toner in the developer) stored in the developing device 24.

Further, in order to deal with deterioration of carrier of the two-component developer 8 stored in the developer storage container 24a, each of the developing devices 24 (Y, M, C, K, SA, and SB) employs a so-called trickle development system such that a portion of the developer 8 (magnetic carrier and non-magnetic toner attached thereto) is discharged outside the developing device 24 as waste developer. This operation of discharging a portion of the developer is performed by an overflow mechanism 24e (FIG. 2). At an end of the developer storage container 24a, the overflow mechanism 24e allows a portion of the developer transported by the agitating and transport member 24c at a level higher than the predetermined level to overflow from an overflow port so as to be gathered. The waste developer discharged from each developing device 24 is finally collected by the waste developer collection system 100.

The drum cleaning device 26 includes an elastic blade 26a that contacts the peripheral surface of the photoconductor drum 21 having passed through a first transfer position so as to remove attached substances such as residual toner, and a sending member 26b that gathers the attached substances such as toner removed by the elastic blade 26a as waste developer, and sends the waste developer to the waste developer collection system 100.

As best shown in FIG. 1, the intermediate transfer device 30 of the image output unit 2 is arranged under the image forming devices 20 (Y, M, C, K, SA, and SB). This intermediate transfer device 30 generally includes an intermediate transfer belt 31 that rotates in the direction indicated by the arrow while passing through the first transfer position between the photoconductor drum 21 and the first transfer device 25 (a first transfer roller), plural support rollers 32a through 32f that rotatably support the intermediate transfer belt 31 from the inner side thereof while holding the intermediate transfer belt 31 in a desired state, a second transfer roller 35 that contacts the peripheral surface of the intermediate transfer belt 31 supported by the support roller 32e at a predetermined pressure and rotates, and a belt cleaning device 36 that removes attached substances, such as toner and paper particles, remaining on and attached to the peripheral surface of the intermediate transfer belt 31 after the intermediate transfer belt 31 passes through the second transfer roller 35.

The belt cleaning device 36 includes an elastic blade 36a that contacts the peripheral surface of the intermediate transfer belt 31 having passed through a second transfer position so as to remove attached substances such as residual toner, a rotating brush 36b that contacts the peripheral surface of the intermediate transfer belt 31 at the upstream side of the elastic blade 36a in the rotational direction so as to remove attached substances, and a sending member 36c that gathers the attached substances such as toners removed by the elastic blade 36a and the rotating brush 36b as waste developer, and drives and sends the waste developer to the waste developer collection system 100.

The fixing device 45 of the image output unit 2 includes, inside a housing 46, a heating rotor 47 that rotates in the direction indicated by the arrow and is heated by a heater such that the surface temperature thereof is maintained at a predetermined temperature, and a pressure rotor 48 that contacts the heating rotor 47 substantially along the axial direction thereof so as to be driven thereby. The recording paper 9 with an image formed thereon after completion of fixing of toner images by the fixing device 45 passes through a discharge transport path including plural transport rollers and transport guide members to a discharge section provided in the housing 10 or other positions so as to be stored therein.

The paper feed device 40 of the paper feed unit 4 is arranged under the intermediate transfer device 30. The paper feed device 40 is attached so as to be pulled out toward the front side (the side that the user faces during use) of the housing 10. The paper feed device 40 generally includes one (or more) paper cassette 41 in which recording paper 9 of the desired size and desired type is stacked, and a sending device 42 that sends the recording paper 9 one by one from the paper cassette 41. Further, the paper feed path 43 of the paper feed unit 4 includes plural paper transport roller pairs 43a, 43b, 43c, and so on and transport guide members that are arranged so as to connect the sending device 42 of the paper feed device 40 and the second transfer position (between the intermediate transfer belt 31 and the second transfer roller 35) of the intermediate transfer device 30.

A control device (a central controller and controllers described below) 7 includes an arithmetic processing unit, storage element and device, a control device, and input/output device. The control device 7 executes predetermined control operations on the basis of a control program and data stored in the storage element. The storage element and storage device include storage elements such as ROM and RAM, and external storage devices such as magnetic disk devices.

As shown in FIG. 8, the control device 7 is connected to detectors such as the above-described toner density detection sensor 29, the image processing device 12, the external connection communication unit 13, and an input/display device (such as an operation panel) 14 that inputs and displays various types of information. Thus, information required for control operations are input to the control device 7 from these connected components. Further, the control device 7 is connected to the image forming device 20 of the image output unit 2, an image output unit controller 71 that controls operations of the intermediate transfer device 30 and the fixing device 45, a collection system controller 72 that controls operations of the waste developer collection system 100 (described below), the image processing device 12, the external connection communication unit 13, and the input/display device 14, and the like. Thus, the control device 7 transmits control signals required for the operations of these connected components.

(Operations of Image Forming Apparatus)

The image forming apparatus 1 performs basic image forming operations described below. The following describes a pattern (full-color mode) of an image forming operation for forming a full-color image by combining toner images of four colors (Y, M, C, and K) which are formed using all of the four image forming devices 20 (Y, M, C, and K) of the image output unit 2.

When the control device 7 receives a request for an image forming operation (a print operation) from any of the above-described image information devices through the external connection communication unit 13, the image output unit 2, the paper feed unit 4, and the like are started. In each of the four image forming devices 20 (Y, M, C, and K) of the image output unit 2, the photoconductor drum 21 rotates in the direction indicated by the arrow, and the charging device 22 charges the peripheral surface of the photoconductor drum 21 to a predetermined polarity (negative polarity in the first exemplary embodiment) and to a predetermined potential. Then, the exposure device 23 performs exposure by radiating light to the charged peripheral surface of the photoconductor drum 21 on the basis of image data decomposed into color components (Y, M, C, and K) which are transmitted from the image processing device 12. Thus, electrostatic latent images of the respective color components having predetermined potential differences are formed.

Then, the developing device 24 (Y, M, C, and K) supplies a toner of the corresponding color (Y, M, C, and K) charged to a predetermined polarity (negative polarity) to the electrostatic latent image of the corresponding color component formed on the photoconductor drum 21 so as to electrostatically attach the toner thereto. The electrostatic latent image of the corresponding color component on the photoconductor drum 21 passes through the developing device 24. Thus, the electrostatic latent images are developed with the toners of the corresponding colors so as to become visible as toner images of four colors (Y, M, C, and K).

Then, the toner images of the respective colors formed on the photoconductor drums 21 of the image forming devices 20 (Y, M, C, and K) are first-transferred onto the intermediate transfer belt 31 of the intermediate transfer device 30 by the first transfer devices 25 such that the toner images are sequentially superimposed. The intermediate transfer device 30 holds and transports the first-transferred toner images on the intermediate transfer belt 31 to the second transfer position. Then, the toner images are second-transferred all at once by the second transfer roller 35 onto recording paper 9 that is transported and sent through the paper feed path 43 from the paper feed device 40 of the paper feed unit 4.

Then, the recording paper 9 with the toner images second-transferred thereon is removed from the intermediate transfer belt 31. The recording paper 9 is introduced into the fixing device 45 and is subjected to a required fixing process (heating and pressurizing operation) such that the toner images are fixed thereon. Thus, an image is formed. Finally, in the case of an image forming operation for forming an image on only one side, the recording paper 9 with the image fixed thereon is discharged and stored in a discharge storage section (not shown) in the housing 10, for example.

With the image forming operation described above, the recording paper 9 with a full-color image formed thereon by combining toner images of four colors is output from the image output unit 2. If the image forming operation is requested to be performed on plural sheets of paper is requested, the above-described image forming operation is repeatedly performed substantially in the same manner.

In the image forming apparatus 1, in the case of forming toner images of the special colors of SA and SB, the image forming devices 20SA and 20SB performs the same operations as the above-described image forming devices 20 (Y, M, C, and K) and thereby form toner images of the special colors SA and SB on their photoconductor drums 21. The toner images of the special colors SA and SB formed by the image forming devices 20SA and 20SB are finally transferred onto the recording paper 9 (together with the toner images of the other colors) by the intermediate transfer device 30 and are fixed by the fixing devices 45.

In the image forming apparatuses 1, when the detection result of the toner density detection sensor 29 of the developing device 24 becomes equal to or less than a setting value, the replenishment device 53 operates for a predetermined time such that developer is replenished from the corresponding developer cartridge 50 to the subject developing device 24.

Further, in the image forming apparatus 1, during execution of an image forming operation or the like, unwanted substances such as toner remaining on the peripheral surfaces of each of the photoconductor drums 21 of the image forming devices 20 (Y, M, C, K, SA, and SB) of the image output unit 2 after the first transfer are removed and gathered by the drum cleaning device 26, and then are discharged as waste developer 81 as shown in FIG. 3. Also, unwanted substances such as toner remaining on the peripheral surface of the intermediate transfer belt 31 of the intermediate transfer device 30 of the image output unit 2 are removed and gathered by the belt cleaning device 36, and then are discharged as waste developer 82. Also, in each of the developing devices 24 (Y, M, C, K, SA, and SB) of the respective image forming devices 20, part of the developer is caused to overflow by the above-described trickle development system, is gathered, and then is discharged outside as waste developer 83.

The most part of the waste developer 81 removed by the drum cleaning device 26 is toner that is not transferred upon the first transfer, and the most part of the waste developer 82 removed by the belt cleaning device 36 is toner that is not transferred upon the second transfer. Further, in each developing device 24, carrier and toner attached to the carrier are discharged as the waste developer 83.

Further, in the image forming apparatus 1, both the waste developers 81 and 82 gathered and discharged by the drum cleaning device 26 and the belt cleaning device 36 and the waste developer 83 gathered and discharged by each developing device 24 are collected by the waste developer collection system 100 (described below).

(Configuration of Waste Developer Collection System)

Next, the waste developer collection system 100 will be described.

As best shown in FIG. 3, the waste developer collection system 100 includes two collection containers 200A and 200B that finally collect together the waste developers 81 through 83, which are discharged from the drum cleaning devices 26 of the image output unit 2, the belt cleaning device 36, and the developing devices 24, respectively, and a transport device 102 that gathers and transports the waste developers 81 through 83 discharged from the drum cleaning devices 26, the belt cleaning device 36, and the developing devices 24 to either one of the two collection containers 200A and 200B.

The transport device 102 includes a first transport device 110 that collectively transports waste developers discharged from the drum cleaning devices 26 and the developing devices 24 of the image forming devices 20 (Y, M, C, K, SA, and SB), a second transport device 120 that transports toner discharged from the belt cleaning device 36 of the intermediate transfer device 30, a third transport device 130 that collectively transports the waste developers transported by the first transport device 110 and the second transport device 120, and a fourth (final) transport device 140 that finally transports the waste developers transported by the third transport device 130 to either one of the collection containers 200A and 200B.

The above-described first transport device 110 includes a first transport pipe 112 extending in the substantially horizontal direction (the direction indicated by the X-coordinate axis) under the image forming devices 20 (Y, M, C, K, SA, and SB) at a rear portion of the housing 10, a transport member such as a screw auger (not shown) that rotates in the internal space of the first transport pipe 112 so as to transport the waste developers 81 and 83 toward the downstream side in the transport direction thereof, and a driving device that provides rotational power to the transport member. The transport direction is the direction indicated by the arrow near the first transport pipe 112 shown in FIG. 3 (the transport directions of the below-described transport pipes are the same as this transport direction).

Connection transport devices 115 (Y, M, C, K, SA, and SB) that connect waste developer outlet ports of the drum cleaning devices 26 and waste developer outlet ports of the developing devices 24 of the image forming devices 20 (Y, M, C, K, SA, and SB), respectively, and transport the waste developers (81 and 83) are connected to the first transport pipe 112 of the first transport device 110. Each connection transport device 115 includes a tubular member 116 extending in the substantially vertical direction (the perpendicular direction along the Y-coordinate axis) connecting the outlet port of the drum cleaning device 26 and developing device 24 of each image forming device 20 and the first transport pipe 112, a scraping member such as a coil spring (not shown) that vertically advances and retracts in a vibrating manner in the internal space of the tubular member 116 so as to scrape waste developer and the like attached to the inner wall thereof, and a driving device that provides power for advancement and retraction motions of the scraping member.

The above-described second transport device 120 includes a second transport pipe 122 extending in the substantially horizontal direction under the belt cleaning device 36 of the intermediate transfer device 30 at a rear portion of the housing 10, a transport member such as a screw auger (not shown) that rotates in the internal space of the second transport pipe 122 so as to transport the waste developer 82 toward the downstream side in the transport direction thereof, and a driving device that provides rotational power to the transport member. The downstream side of the second transport device 120 in the transport direction is connected to a downstream end of the first transport pipe 112 of the first transport device 110 such that the internal spaces thereof communicate with each other.

A connection transport device 125 that is connected to the waste developer outlet port of the belt cleaning device 36 so as to transport toner is connected to the second transport pipe 122 of the second transport device 120. The connection transport device 125 includes at least a tubular member extending substantially vertically so as to connect the outlet port of the belt cleaning device 36 and the second transport pipe 122. Note that in the case where the third transport device 130 is disposed on a side opposite to the image forming devices 20 with respect to the belt cleaning device 36, there is no need to provide the second transport device 120, and the connection transport device 125 may be connected to a part of the first transport pipe 112 of the first transport device 110, for example. Further, it is obvious that in the case where there is no belt cleaning device 36 (in the case where an intermediate transfer system is not employed in the image output unit 2), there is no need to provide the second transport device 120.

The third transport device 130 includes a tubular member 132 extending substantially vertically from a junction between the first transport pipe 112 of the first transport device 110 and the second transport pipe 122 of the second transport device 120 toward the fourth transport device 140 that is located at the lower side in the direction of gravitational force (the direction substantially along the Y-coordinate axis), a scraping member such as a coil spring (not shown) that vertically advances and retracts in a vibrating manner in the internal space of the tubular member 132 so as to scrape the waste developers (81 through 83) attached to the inner wall thereof, and a driving device that provides power for advancement and retraction motions of the scraping member.

The above-described fourth transport device 140 includes a fourth transport pipe 142 generally extending in the substantially horizontal direction so as to connect at least a lower portion of the tubular member 132 of the third transport device 130 and the inlet port of one collection container 200A (or 200B), a transport member such as a screw auger (not shown) that rotates in the internal space of the fourth transport pipe 142 so as to transport the waste developers 81 and 83 toward the downstream side (more specifically, a below-described outlet port) in the transport direction thereof, and a driving device that provides rotational power to the transport member.

As the first transport pipe 112, second transport pipe 122, and fourth transport pipe 142 of the transport device 102, cylindrical pipes may be used, for example. As the third transport pipe 132, a tubular member having a cross-sectional circular diameter that decreases toward the lower side of the internal space may be used, for example.

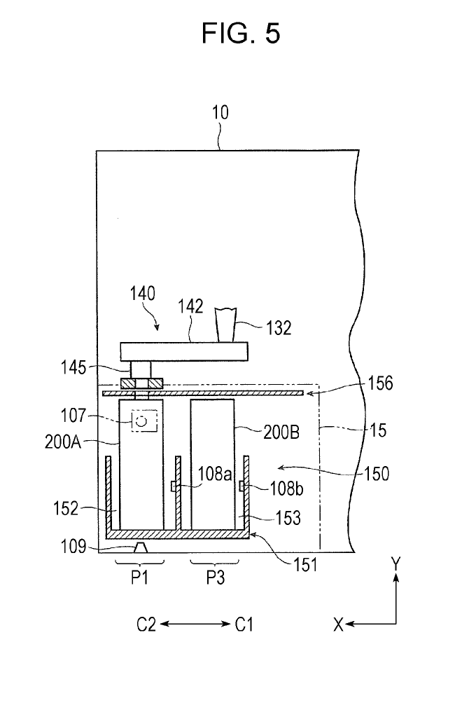

With regard to the fourth transport pipe 142, referring to FIG. 5, at a portion of the upper surface thereof that is connected to the tubular member 132 of the third transport device 130, a connection port (an inlet port) (not shown) is provided for receiving the waste developers 81 through 83 transported through the tubular member 132. Further, with regard to the fourth transport pipe 142, at a portion of the lower surface thereof at the downstream side in the direction of gravitational force that is connected to the inlet port of the collection container 200, an outlet port (a discharge portion) 145 from which the waste developer transported from the fourth transport pipe 142 falls and is discharged into the collection container 200 is provided. The outlet port 145 is a cylindrical protrusion protruding toward the lower side in the direction of gravitational force.

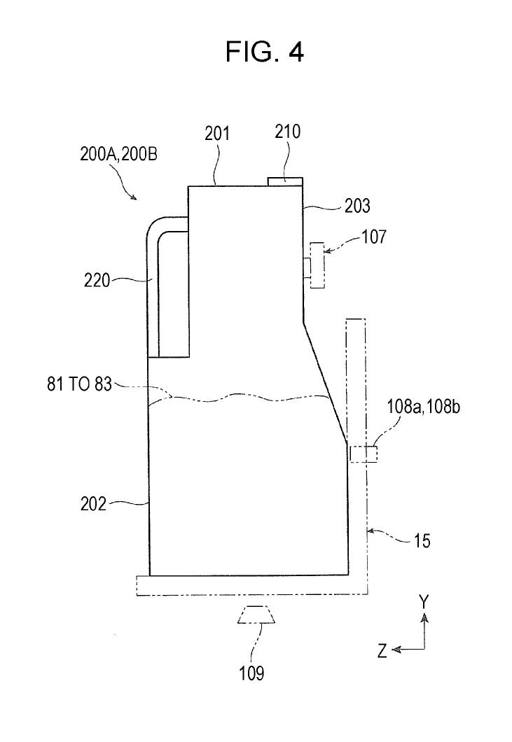

As shown in FIGS. 3 and 4, the collection containers 200A and 200B of the collection system 100 are containers having the substantially same rectangular external shape. Each of the collection containers 200A and 200B has an inlet port 210 for receiving the waste developers (81 through 83) at an upper surface 201 thereof, and has a handle 220 on one side surface 202 thereof.

Further, the collection containers 200A and 200B are detachable and replaceable containers which may be detachably attached to a container attachment section (space) 15 formed at a lower rear portion of the housing 10 of the image forming apparatus 1 and may be easily replaced. That is, as best shown in FIG. 5, the collection containers 200A and 200B are detachably attached to a moving device 150 that moves the collection containers 200 together in the container attachment section 15 of the housing 10 such that the collection containers 200 reach and are stopped at the predetermined positions.

The moving device 150 includes a moving base 151 that is arranged to be reciprocally movable in predetermined directions C1 and C2 indicated by the double-headed arrow in the container attachment section 15. The collection containers 200A and 200B are allocated to and detachably attached to two container attachment portions 152 and 153 provided in the moving base 151.

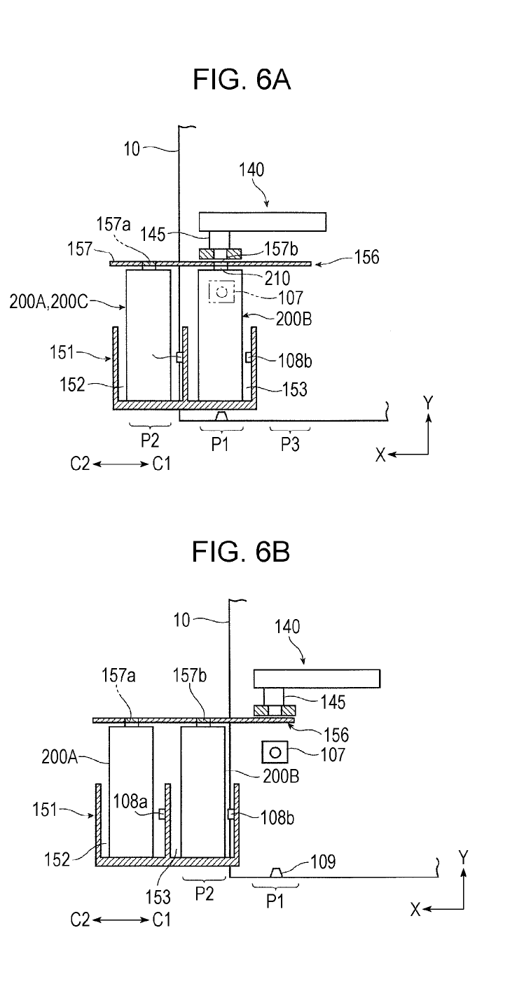

As shown in FIGS. 5, 6A, and 6B, the moving base 151 moves such that desired collection containers 200 reach and stopped respectively at predetermined arrangement positions including a collection position P1 at which the inlet port 210 of the collection container 200 is connected to the discharge portion 145 of the fourth transport pipe 142 of the transport device 102, an attachment/detachment position P2 for attaching the collection container 200 to or detaching the collection container 200 from the moving base 151 (the container attachment section 15) for replacement or inspection, and a standby position P3 at which the collection container 200 temporarily stays in the container attachment section 15. Note that, as shown in FIGS. 6A and 6B, the attachment/detachment position P2 in the first exemplary embodiment is set to a position where the container attachment portion 152 (153) to which the collection container 200 to be replaced is attached is exposed outside the housing 10 (the container attachment section 15). Further, the moving base 151 is configured to be manually moved and stopped at a predetermined position by the user of the image forming apparatus or the like.

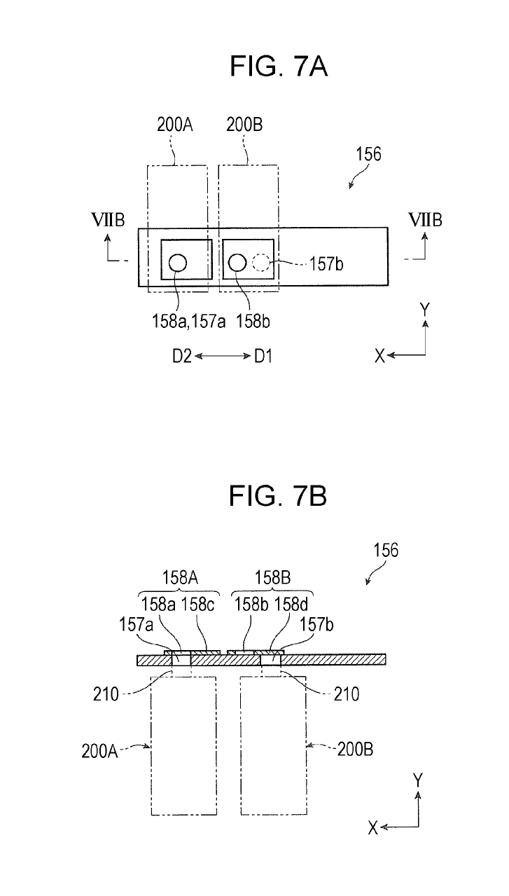

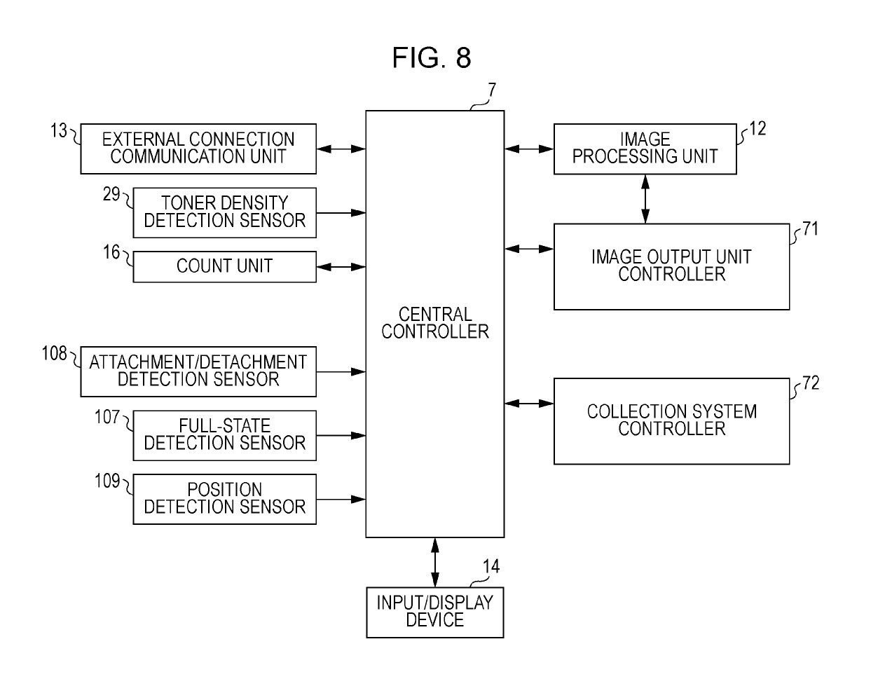

Further, as shown in FIGS. 3 and 5, the moving base 151 is provided with an openable shutter 156 that opens the inlet port 210 of each of the collection containers 200A and 200B when connected to the outlet port 145 of the fourth transport pipe 142, and otherwise closes the inlet port 210. For example, as shown in FIGS. 7A and 7B, the openable shutter 156 is fixed to the moving base 151, and includes a plate-shaped fixed member 157 in which through holes 157a and 157b that face the inlet ports 210 of the collection containers 200A and 200B attached to the container attachment portions 152 and 153 are provided, and two plate-shaped movable members 158A and 158B which are attached so as to be movable with respect to the fixed member 157 in the directions indicated by the double-headed arrow D1 and D2 and in which through holes 158a and 158b that may face the through holes 157a and 157b, respectively, of the fixed member 157, and non-through portions 158c and 158d that close the through holes 157a and 157b, respectively, are provided.

This openable shutter 156 is configured such that, when the movable members 158A and 158B are moved and stopped at the collection position P1 by the movement of the moving device 150 (the moving base 151), the movable members 158A and 158B move relative to the fixed member 157 in the direction indicated by the arrow D1, for example, so as to place the through holes 157 of the fixed member 157 into an open state (a through state), and when the movable members 158A and 158B are located at the other arrangement positions (P2 and P3) than the collection position P1, the movable members 158A and 158B (move in the direction indicated by the arrow D2, for example, so as to) place the through holes 157 of the fixed member 157 into a closed state (a non-through state). Note that the openable shutter 156 is not limited the one described above. For example, a simplified openable shutter may be used which does not include two plate-shaped movable members 158A and 158B and only includes a fixed member 157. In this case, each of though holes 157a and 157b of the fixed member 157 is open when facing the outlet port 145 of the fourth transport pipe 142, and is closed when not facing the outlet port 145.

Further, as best shown in FIG. 5, the moving base 151 includes attachment/detachment detection sensors 108a and 108b configured to detect that the collection containers 200 are attached to and detached from the two container attachment portions 152 and 153, respectively. The attachment/detachment detection sensor 108 may be, for example, a sensor that directly detects whether the collection container 200 is present when the collection container 200 is attached or detached.

Further, as best shown in FIG. 5, in the moving device 150, a position detection sensor 109 is provided that detects the collection container 200A or 200B which is moved and stopped at the collection position P1 by the moving device 150. The position detection sensor 109 may be, for example, a sensor that is disposed at the bottom directly under the collection position P1 of the container attachment section 15 and is capable of directly identifying the collection container 200 stopped at the collection position P1, or may be a sensor that detects which one of the container attachment portions 152 and 153 of the moving base 151 is stopped at the collection position P1 and thereby indirectly identifies the collection container 200 attached to the detected one of the container attachment portions 152 and 153.

Further, as shown in FIGS. 4 and 5, at the collection position P1 of the container attachment section 15, a full-state detection sensor 107 is provided that detects that amount of the waste developer (81 through 83) stored in the collection container 200A or 200B stopped at the collection position P1 has reached a predetermined storage amount (the amount slightly less than the completely full amount: an almost full state). The full-state detection sensor 107 may be, for example, a magnetic permeability sensor that measures the magnetic permeability of the magnetic carrier contained in the waste developer and thereby detects that the storage amount (storage state) of the non-magnetic toner and the magnetic carrier is equal to or greater than a predetermined storage amount, or an optical sensor that radiates light to the collection container 200 at a predetermined height position and thereby detects the storage amount on the basis of whether the light is blocked by the waste developer and is not received or the light is transmitted without being blocked and is received. The full-state detection sensor 107 is arranged at a position facing a side surface 203 opposite to the side surface 202 on which the handle 220 of the collection container 200 stopped at the collection position P1 is formed.

Further, as shown in FIG. 8, the above-described full-state detection sensor 107, attachment/detachment detection sensor 108, and position detection sensor 109 are connected to the control device 7, and detection results thereof are transmitted thereto. The collection system controller 72 connected to the control device 7 is connected to driving devices (not shown) that provide rotational power to the transport members of the transport device 102, and transmits predetermined control signals for the rotating operations to the driving devices.

Then, in this collection system 100, as will be described below, one of the two collection containers 200A and 200B (the collection container 200B in the present exemplary embodiment) is used as a so-called buffer container for temporarily storing waste developer and is preferentially moved to the collection position P1 so as to store the waste developers (81 through 83) when the other collection container (the collection container 200A in the present exemplary embodiment) is moved from the collection position P1 to the attachment/detachment position P2 by the moving device 150 and detached therefrom after being detected by the full-state detection sensor 107.

In the first exemplary embodiment, as shown in FIG. 5, the collection container 200B that is selected to be used as a buffer container is attached to the second container attachment portion 153 located at the far side (the side in the direction indicated by the arrow C1) of the container attachment section 15 on the moving base 151 of the moving device 150. Further, the other collection container 200A is attached to the first container attachment portion 152 at the near side of the container attachment section 15 on the moving base 151 of the moving device 150.

As shown in FIG. 6B, after the moving base 151 of the moving device 150 is pulled out to a position where the container attachment portions 152 and 153 are exposed outside the housing 10, these two collection containers 200A and 200B are attached to the exposed container attachment portions 152 and 153, respectively. When these two collection containers 200A and 200B are attached, the attachment/detachment detection sensors 108a and 108b detect that the two collection containers 200A and 200B are attached to the container attachment portions 152 and 153, respectively. As shown in FIG. 6B, the collection containers 200A and 200B are attached such that the inlet ports 210 thereof face the through holes 157a and 157b, respectively, of the fixed member 157 of the openable shutter 156 on the moving base 151. Note that when the two collection containers 200A and 200B are located at the attachment/detachment positions P2, the through holes 157a and 157b in the fixed member 157 of the openable shutter 156 are closed by the non-through portions 158c and 158d of the movable member 158.

As shown in FIG. 5, the collection containers 200A and 200B attached to the container attachment portions 152 and 153 of the moving base 151 are moved in the direction of pulling in the moving base 151 toward the end of the housing 10 such that the collection container 200A reach and stopped at the collection position P1 and the collection container 200B reach and stopped at the standby position P3. At this point, the position detection sensor 109 detects that the collection container stopped and located at the collection position P1 is the collection container 200A. Further, at this point, in the openable shutter 156 (FIG. 5), the through hole 157a of the fixed member 157 that is facing the collection container 200A located at the collection position P1 is opened through the through hole 158a of the movable member 158, and the outlet port 145 of the fourth transport pipe 142 of the fourth transport device 140 is open to allow communication. As a result, the inlet port 210 of the collection container 200A is connected to the outlet port 145 of the fourth transport pipe 142.

Further, as will be described below, the collection system 100 (the collection system controller 72 of the control device 7) is configured to issue a notification for prompting, when the full-state detection sensor 107 detects that the collection container 200 located at the collection position P1 is in an almost full state, the user of the image forming apparatus 1 to replace the detected collection container 200. The notification may be performed by, for example, displaying a warning message that prompts replacement on the display screen of the input/display device 14 or the external connection device. At this point, the position detection sensor 109 detects which of the collection containers 200 is stopped at the collection position P1.

Further, in order to prevent waste developer from overflowing from the detected collection container 200 without being stored due to the collection container 200 not being replaced for a long time, as best shown in FIG. 8, the collection system 100 is provided with a counter (count unit) 16 that counts a predetermined subject element e that allows prediction of occurrence of such a problematic event. When the collection system 100 (the collection system controller 72 of the control device 7) detects that the counted value of subject element e counted by the counter 16 has exceeded a preset setting value (threshold) N, the collection system 100 forcibly stops the image forming operation, and prevents the image forming operation from being executed until the subject collection container 200 is replaced. Examples of the subject element e include the number of sheets on which images are formed (the number of printed sheets), and the elapsed time.

Further, the collection system 100 (the collection system controller 72 of the control device 7) is configured to, when the collection container 200 to be replaced is moved and stopped at the attachment/detachment position P2 and detached therefrom and then a new collection container 200 is attached, a notification for prompting movement of the new collection container 200 back to the collection position P1. The notification may be performed by, for example, displaying a warning message that prompts return to the collection position P1 on the display screen of the input/display device 14 or the external connection device. At this point, the detachment of the subject collection container 200 (detected to be in an almost full state) from the attachment/detachment position P2 is detected by the attachment/detachment detection sensor 108a (108b) disposed at the container attachment portion 152 (153) where the subject collection container 200 is attached.

(Operations of Waste Developer Collection System)

The collection system 100 basically operates in the manner as described below.

First, the collection system 100 operates at least during execution of an image forming operation (a print operation) by the above-described image output unit 2. That is, in the collection system 100, when an image forming operation is started, the driving devices in the transport device 102 are activated, so that the transport members and the scraping member start rotating or advancing and retracting.

First, in the first transport device 110 of the transport device 102, the waste developers 81 and 83 that are gathered and discharge by gathering units of the drum cleaning device 26 of each image forming device 20 and (the overflow mechanism 24e of) each developing device 24, respectively, fall through the tubular member 116 of each of the connection transport devices 115 (Y, M, C, K, SA, and SB), and are received and gathered into the internal space of the first transport pipe 112. Then, the waste developers 81 and 83 are transported through the internal space of the first transport pipe 112 in the transport direction indicated by the arrow by the rotating transport member. Further, in the second transport device 120 of the transport device 102, the waste developer 82 that is discharged from the belt cleaning device 36 of the intermediate transfer device 30 free-falls through the tubular member of the connection transport device 125, is received into the internal space of the second transport pipe 122. Then, the waste developer 82 is transported in the transport direction indicated by the arrow by the rotating transport member.

Subsequently, in the third transport device 130 of the transport device 102, the waste developers 81 through 83 that are transported by the first transport device 110 and the second transport device 120 in the respective transport directions and are gathered into one location (combining section) fall through the tubular member 132, and are received into the internal space of the fourth transport pipe 142 of the fourth transport device 140.

Then, in the fourth transport device 140 of the transport device 102, the waste developers 81 through 83 that are received by the fourth transport pipe 142 are transported so as to be moved in the transport direction indicated by the arrow by the transport member rotating in the internal space of the fourth transport pipe 142, and fall when the waste developers 81 through 83 reach the outlet port 145 of the fourth transport pipe 142. Thus, the waste developers 81 through 83 that are transported by the transport device 102 are stored together through the inlet port 210 of the collection container 200 (generally the collection container 200A) stopped at the collection position P1 into the storage space thereof.

Next, a description will be given of operations for handling the two collection containers 200A and 200B in the collection system 100 during execution of an image forming operation.

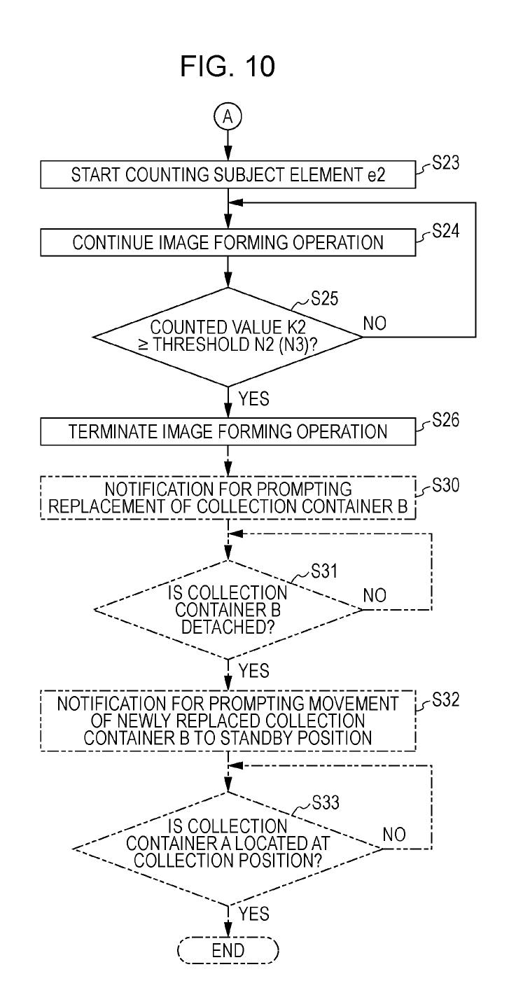

First, in the collection system 100, when an image forming operation by the image output unit 2 is started (permitted), as shown in FIG. 9, a detection is performed to determine whether two collection containers 200A and 200B to be used in the collection system 100 are attached (step S10, hereinafter simply referred to also as “S10”. The same applies to other steps). This detection is performed by the attachment/detachment detection sensors 108a and 108b disposed on the moving base 151 of the moving device 150.

At this point, if attachment of the two collection containers 200A and 200B is detected, the full-state detection sensor 107 disposed at the collection position P1 starts a full-state detection (a detection of an almost full state) (S12). On the other hand, if attachment of at least one of the two collection containers 200A and 200B is not detected, the started image forming operation is suspended (S11). In this case, for example, the collection system controller 72 or the like executes a notifying operation, such as displaying a warning message, so as to prompt attachment of the collection container 200.

After that, the full-state detection sensor 107 starts a full-state detection. If the control device 7 confirms that the full-state detection sensor 107 has detected an almost full state (S13), an operation for identifying the collection container 200 stopped at the collection position P1 is performed (S14). This identification operation is performed on the basis of the detection result of the position detection sensor 109 disposed in the moving device 150.

If the collection container 200 is identified as a “collection container A” in step S14, the control device 7 (the collection system controller 72) executes a notifying operation for displaying a warning message that prompts replacement of the collection container A (step S15), and a counting operation for counting a subject element e1 is started (S16). The subject element e1 may be the number of sheets on which images are formed or the elapsed time as mentioned above, and is counted by the counter 16. Subsequently, a detection is performed to determine whether the collection container 200A to be replaced is moved to the attachment/detachment position P2 and is detached therefrom (S17).

As shown in FIG. 6A, the collection container 200A to be replaced is detached after moving the moving base 151 of the moving device 150 such that the collection container 200A is moved from the collection position P1 (FIG. 5) and stopped at the attachment/detachment position P2 (FIG. 6A). More specifically, the collection container 200A detected to be in an almost full state is detached from the first container attachment portion 152 of the moving base 151, and then a new collection container 200(C) is attached to the first container attachment portion 152. Detachment of the collection container 200A and attachment of the collection container 200C in this step are detected by the attachment/detachment detection sensor 108a disposed in the first container attachment portion 152 of the moving base 151.

This collection system 100 performs an operation of moving the moving base 151 of the moving device 150 in the direction indicated by an arrow C2 and thereby moves the collection container 200A to be replaced from the collection position P1 to the attachment/detachment position P2. Then, as shown in FIGS. 5 and 6A, the collection container 200B attached to the second container attachment portion 153 of the moving base 151 is moved together (in unison), so that the collection container 200B is moved from the standby position P3 and stopped at the collection position P1 (FIG. 6A).

At this point, in the openable shutter 156, the through hole 157b of the fixed member 157 facing the collection container 200B is opened by the through hole 158b of the movable member 158. Thus, the inlet port 210 of the collection container 200B is connected to the outlet port 145 of the fourth transport pipe 142 of the fourth transport device 140. Further, at this point, since the image forming operation is performed by the image output unit 2 in the image forming apparatus 1, the transport device 102 continues to transport the waste developers (81 through 83) discharged from the drum cleaning devices 26 and the like of the image output unit 2. These transported waste developers are stored in the collection container 200B. That is, the collection container 200B is preferentially moved to the collection position P1 when the collection container 200A to be replaced is detached and replaced at the attachment/detachment position P2, and is used as a buffer container that temporarily stores waste developer which is discharged during the replacement operation. As a result, even if the collection container 200A is replaced during execution of an image forming operation, waste developer discharged by the image forming operation is temporarily stored in the collection container 200B. Therefore, there is no need to stop the ongoing image forming operation.

In step S17, if detachment of the collection container 200A from the first container attachment portion 152 is detected, a warning message is displayed that prompts movement of a newly replaced collection container 200 back to the collection position P1 (S18). Then, a determination is made on whether the newly replaced collection container 200(C) is moved and located at the collection position P1, on the basis of the detection result of the position detection sensor 109 (S19). If the new collection container 200(C) is determined to be located at the collection position P1, the ongoing image forming operation continues to be executed without being forcibly suspended (S20). In this case, the collection system 100 continues to operate while returning to step S10 and performing the above described steps.

Accordingly, in this image forming apparatus 1 (the collection system 100), one collection container (200B in the first exemplary embodiment) out of the two collection containers 200A and 200B may be used as a buffer container for temporarily storing waste developer. Further, since one collection container 200B may be used as a buffer container, the collection container 200A that is detected to be in an almost full state may be replaced without terminating the ongoing image forming operation. Further, the collection container 200B selected as a buffer container may have the same configuration as the other collection container 200A (200C) dedicated to collection, there is no need to prepare, as the collection container 200B, a special collection container having a different configuration, and an increase in the cost may be prevented. Thus, the entire image forming apparatus 1 (the collection system 100) may be implemented with a simple configuration.

Note that if detachment of the collection container 200A to be replaced is not detected in step S17, a determination is made on whether the counted value K1 of the subject element e1 counted by the counter 16 is equal to or greater than a threshold N1 (S21).

When the counted value K1 is less than the threshold N1, the process returns to step S17 so that a determination of whether the collection container 200A to be replaced is detached is repeatedly made. On the other hand, if the counted value K1 becomes equal to or greater than the threshold N1, the ongoing image forming operation is terminated (S22). Thus, if the collection container 200A is not replaced for a long time despite a notification for prompting replacement of the collection container 200A, the image forming operation of the image output unit 2 is terminated, so that waste developer is not discharged into the collection system 100. As a result, it the occurrence of an event in which the waste developer stored in the collection container 200A to be replaced exceeds the storage capacity thereof and thus the excess waste developer overflows from the inlet port 210 may be reduced or prevented.

On the other hand, in step S14, there may be a case in which the collection container at the collection position P1 is detected to be full by the full-state detection sensor 107 is identified as a “collection container B”.

This is because although the selected collection container B is generally used as a buffer container for temporarily storing the waste developer discharged from the image output unit 2 while replacing the other collection container 200A (including the newly replaced collection container 200C), the collection container 200B is moved to the collection position P1 and receives waste developer multiple times, so that the waste developer is gradually accumulated therein (FIG. 6A) and eventually the waste developer storage state thereof reaches the level of the almost full state to be detected by the full-state detection sensor 107.

In this case, as shown in FIG. 10, the control device 7 (the collection system controller 72) starts counting the subject element e2 for the collection container B (S23), and the ongoing image forming operation continues to be executed for the moment (S24). The subject element e2 may be the number of sheets on which images are formed or the elapsed time as mentioned above, and is counted by the counter 16. The subject element e2 used herein is usually the same as the subject element e1 used for the collection container 200A. However, the subject element e2 may be an element different from the subject element e1.

Then, a determination is made on whether the counted value K2 of the subject element e2 counted by the counter 16 is equal to or greater than a threshold N2 (S25). When the counted value K2 is less than the threshold N2, the ongoing image forming operation continues to be executed. However, if the counted value K2 becomes equal to or greater than the threshold N2, the waste developer storage state of the collection container 200B is determined to reach a completely full state, so that the ongoing image forming operation is forcibly terminated (S26).

In response to the termination of the image forming operation in step S26, since the image forming operation of the image output unit 2 is terminated, waste developer is not discharged into the collection system 100. As a result, the occurrence of an event in which the waste developer stored in the collection container 200B to be replaced exceeds the storage capacity thereof and thus the excess waste developer overflows from the inlet port 210 may be reduced or prevented. The threshold N2 for the counted value K2 in step S25 may be set to the same value as the value of the threshold N1 of the counted value K1 used for the collection container 200A in the case where the subject element e2 of the counted value K2 is the same as the subject element e1 used for the collection container 200A. However, the threshold N2 may be set to a value different from the value of the threshold N1.

Note that if the full-state detection sensor 107 detects that the collection container 200B serving as a buffer container is in an almost full state, the collection container 200 cannot be replaced. This is because, at this point, since the ongoing image forming operation continues to be executed, if the collection container 200 is moved to the attachment/detachment position P2 so as to be replaced (FIG. 6B), no collection container 200 is present at the collection position P1, so that waste developer discharged by the ongoing image forming operation cannot be stored.

Note that, in the collection system 100, the following operation is executed after termination of the image forming operation in step S25.

As indicated by two-dot chain lines in FIG. 10, a notification is first displayed that prompts replacement of the collection container 200B detected to be in a completely full state (S30). Then, a detection is performed to determine whether the collection container 200B is detached from the second container attachment portion 153 of the moving base 151 and is replaced with a new collection container 200B′ (S31). In step S31, if detachment of the collection container 200B from the second container attachment portion 153 is detected, a warning message is displayed that prompts movement of the newly replaced collection container 200B′ back to the standby position P3 (S32). Finally, a determination is repeatedly made on whether the replaced collection container 200C dedicated to collection is located at the collection position P1, on the basis of the detection result of the position detection sensor 109 (S33). If the collection container 200C is determined to be located at the collection position P1, the entire operation process of the collection system 100 during execution of the image forming operation ends.

As shown in FIG. 6B, the collection container 200B to be replaced is detached after moving the moving base 151 of the moving device 150 such that the collection container 200B is moved from the collection position P1 (FIG. 6A) and stopped at the attachment/detachment position P2 (FIG. 6B). More specifically, the collection container 200B detected to be in a completely full state is detached from the second container attachment portion 153, and then a new collection container 200B′ is attached to the second container attachment portion 153. The replaced new collection container 200B′ is moved to the standby position P3 as the moving base 151 of the moving device 150 is moved, and stays at the standby position P3 until the next detachment and replacement of the collection container 200A is performed.

### Second Exemplary Embodiment

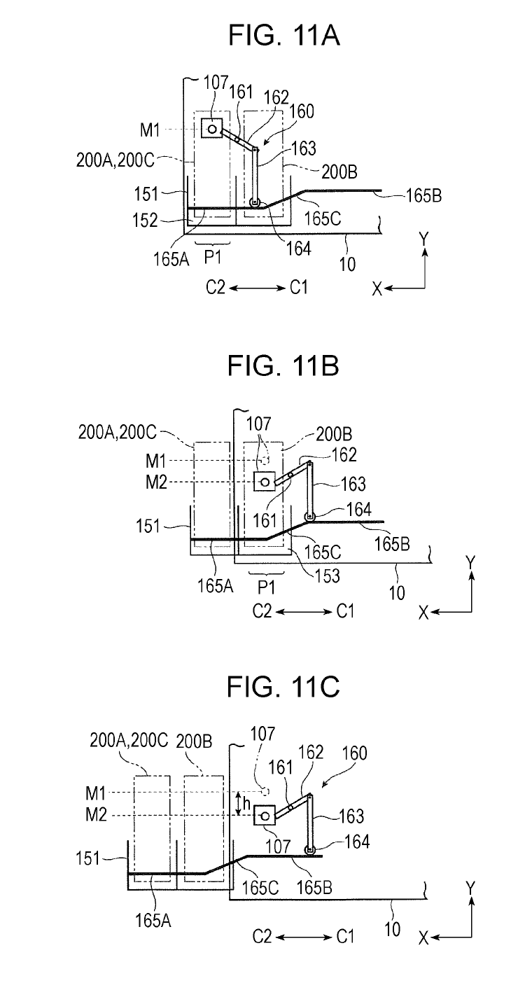

FIGS. 11A through 11C illustrate a part of a waste developer collection system 100 of an image forming apparatus 1 according to a second exemplary embodiment. The collection system 100 of the second exemplary embodiment has the same configuration as the collection system 100 of the image forming apparatus 1 of the first exemplary embodiment except that a full-state detection sensor 107 is configured to move between two detection positions.

As shown in FIGS. 11A through 11C, the full-state detection sensor 107 of the second exemplary embodiment is configured to move, in accordance with a movement of the moving base 151 of the moving device 150, between a first detection position M1 for detecting an almost full state of the other collection container 200A (200C) dedicated to collection and a second detection position M2 located at a lower side of the first detection position M1 in the direction of gravitational force for detecting a predetermined storage state of the collection container 200B selected as a buffer container.

That is, the full-state detection sensor 107 is attached so as to be reciprocally movable between the first detection position M1 and the second detection position M2, and is connected to an interlocking displacement mechanism 160 whose position is moved in accordance with a movement of the moving base 151.

The interlocking displacement mechanism 160 includes a link mechanism that has a set of a support member 162 and a turning member 163. The support member 162 is turnably attached to a support shaft 161 disposed in the container attachment section 15 and has an end that moves such that the full-state detection sensor 107 is displaced between the first detection position M1 and the second detection position M2. The turning member 163 has an end that is turnably connected the other end of the support member 162 and moves such that the end of the support member 162 is displaced between the first detection position M1 and the second detection position M2. The interlocking displacement mechanism 160 further includes a guide rail 165 that is fixed to the moving base 151 and rotates and moves a rotor (a guide wheel) 164 turnably attached to the other end of the turning member 163 such that the rotor 164 rotates so as to be displaced between a height position corresponding to the first detection position M1 and a height position corresponding to the second detection position M2.

The guide rail 165 includes a first guide portion 165A for holding a height position corresponding to the first detection position M1, a second guide portion 165B for holding a height position corresponding to the second detection position M2, and an inclined connection portion 165C for connecting the first guide portion 165A and the second guide portion 165B. The first guide portion 165A is disposed such that the full-state detection sensor 107 is maintained at the first detection position M1 when the collection container 200A (200C) attached to the first container attachment portion 152 of the moving base 151 is moved and stopped at the collection position P1. The second guide portion 165B is disposed such that the full-state detection sensor 107 is maintained at the second detection position M2 when the collection container 200B attached to the second container attachment portion 153 of the moving base 151 is moved and stopped at the collection position P1.

As illustrated in FIG. 11C, the second detection position M2 is lower by a height h relative to the first detection position M1 in the direction of gravitational force. Therefore, as shown in FIGS. 11B and 11C, when the full-state detection sensor 107 detects a storage state of the collection container 200B serving as a buffer container at the second detection position M2, the available space in the collection container 200B for storing more waste developer is greater (larger) than the collection container 200A (200C) dedicated to collection, of which almost full state is detected at the first detection position M1, due to a height difference h between the detection position M1 and the detection position M2.

The following describes operations of the collection system 100 of the second exemplary embodiment.

As shown in FIG. 11A, when the collection container 200 (200C) dedicated to collection which is attached to the first container attachment portion 152 of the moving base 151 is stopped at the collection position P1, the turning member 163 (the rotor 164) of the link mechanism is guided and supported by the first guide portion 165A of the guide rail 165, so that the full-state detection sensor 107 is moved and maintained at the first detection position M1. Accordingly, an almost full state of the collection container 200 (200C) stopped at the collection position P1 is detected by the full-state detection sensor 107 located at the first detection position M1. In this case, in the collection system 100, the above-described operations of steps S15 through S22 shown in FIG. 9 are executed in accordance with the respective states.

As shown in FIG. 11B, when the collection container 200B serving as a buffer container which is attached to the second container attachment portion 153 of the moving base 151 is stopped at the collection position P1, the turning member 163 (the rotor 164) of the link mechanism is guided and supported by the second guide portion 165B of the guide rail 165, so that the full-state detection sensor 107 is moved and maintained at the second detection position M2. Accordingly, a predetermined storage state of the collection container 200B stopped at the collection position P1 is detected by the full-state detection sensor 107 located at the second detection position M2. In this case, in the collection system 100, the above-described operations of steps S23 through S26 shown in FIG. 10 are executed in accordance with the respective states.

In this case, the threshold N2 for the counted value K2 in step S25 is set to a threshold N3 having a value less than the threshold N2 because the storage amount of the collection container 200B at the time of detection by the full-state detection sensor 107 located at the second detection position M2 is less compared to the case where a detection is performed at the first detection position M1. Thus, the time to be taken to reach an expected time at which the collection container 200B becomes completely full after detection of the collection container 200B by the full-state detection sensor 107 is increased. Accordingly, the replacement of the collection container 200B and thus the termination of the ongoing image forming operation may be postponed.

With the configuration described above, according to the collection system 100 of the second exemplary embodiment, since one collection container 200B selected as a buffer container is detected at the second position M2, the detected storage state of the collection container 200B is a state earlier than an almost full state (a state with a storage amount less than that of an almost full state). Further, the collection container 200B may reliably store a certain amount of waste developer even after the detection at the second detection position M2. As a result, replacement of the collection container 200A (200C) detected to be in an almost full state the collection container may be more stably performed, than in the case of the collection system 100 of the first exemplary embodiment, without terminating the ongoing image forming operation.

### Other Exemplary Embodiments

In the first and second exemplary embodiments, the collection system 100 is configured such that the attachment/detachment position P2 of the predetermined arrangement position at which the moving base 151 of the moving device 150 is located outside the housing 10 (FIGS. 6A and 6B). However, the configuration is not limited thereto. For example, the attachment/detachment position P2 may be located inside the housing 10. In the case where this configuration is applied, the standby position P3 is changed to an attachment/detachment position for attaching and detaching the selected collection container 200B. Further, in the case where this configuration is applied, a required structure such as an openable door may be added at a portion of the housing 10 (the container attachment section 15) at the attachment/detachment position P2.

Further, in the first and second exemplary embodiments, the collection system 100 may be configured to be used with the two collection containers 200A and 200 attached thereto. However, the collection system 100 may be configured to be used with three or more collection containers 200 attached thereto. In the case where this configuration is applied, although one collection positions P1 is provided, plural attachment/detachment positions P2 and plural standby positions P3 may be provided if needed. Further, in this case, the number of attachment/detachment detection sensors 108 corresponding to the number of collection containers 200 to be used may be provided.

Further, the image forming apparatus 1 may be an image forming apparatus for forming monochromatic images, or an image forming apparatus in which the intermediate transfer device 30 is not used, and a paper transport device is used that causes the recording paper 9 to pass through the first transfer positions of the plural image forming devices 20. Further, the image forming apparatus 1 may include any plural number of, other than six, image forming devices 20. Further, the developing device 24 may be a developing device that does not perform trickle development (that does not discharge waste developer 83). Further, the waste developer according to the present invention may be any waste developer that contains at least toner. The waste developer may contain substances other than toner, such as carrier, various types of additives, and paper particles.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
an image output unit that forms an image with developer on a recording medium so as to output the image;
a gathering unit that gathers developer not used by the image output unit as waste developer;
a plurality of detachable and replaceable collection containers that store and collect the waste developer gathered by the gathering unit;
a transport device that transports the waste developer gathered by the gathering unit toward one of the plurality of collection containers, the transport device including a discharge portion which is connected to the one of the collection containers so as to allow the transported waste developer to be discharged;
a moving device that moves the plurality of collection containers together such that the plurality of collection containers reach and stop at respective predetermined arrangement positions, the predetermined arrangement positions including a collection position for connection to the discharge portion of the transport device and an attachment/detachment position which is located at a different position from the collection position and at which attachment and detachment for replacement are performed; and
a full-state detector that detects that the one of the collection containers moved and stopped at the collection position by the moving device and storing the waste developer is in an almost full state;
wherein a selected one of the plurality of collection containers is preferentially moved to the collection position so as to store the waste developer when the other one of the collection containers detected by the full-state detector is moved from the collection position to the attachment/detachment position and detached therefrom.

2. The image forming apparatus according to claim 1, further comprising:
a position detector that detects, among the plurality of collection containers, the collection container stopped at the collection position; and
a replacement notifying unit that prompts, when the collection container detected by the position detector is detected by the full-state detector, replacement of the collection container.

3. The image forming apparatus according to claim 1, further comprising:
an attachment/detachment detector that detects that the collection container moved and stopped at the attachment/detachment position by the moving device is attached or detached; and
a notifying unit that prompts movement of the collection container whose attachment is detected by the attachment/detachment detector such that the collection container is moved from the attachment/detachment position and returned to the collection position or another arrangement position by the moving device.

4. The image forming apparatus according to claim 1, wherein when the selected collection container is detected by the full-state detector, the image forming operation being executed by the image output unit is terminated.

5. The image forming apparatus according to claim 1, wherein the full-state detector is configured to move, in accordance with a movement of the moving unit, between a first detection position for detecting an almost full state of the other collection container and a second detection position located at a lower side of the first position in a direction of gravitational force for detecting a storage state of the selected collection container.

6. The image forming apparatus according to claim 5, further comprising:
a counting unit that counts the number of sheets on which images are formed or elapsed time;
wherein the counting unit starts counting when the full-state detector detects the storage state at the second detection position, and the image forming operation being executed by the image output unit is terminated when a counted value reaches a setting value.
